(19) United States
(12) Patent Application Publication
(10) Pub. No.: US 2025/0391926 A1
(43) Pub. Date: Dec. 25, 2025

(54) JELLY ROLL AND BATTERY

(71) Applicant: ZHUHAI COSMX BATTERY CO., LTD., Zhuhai (CN)

(72) Inventors: Jiao Li, Zhuhai (CN); Jialin Fang, Zhuhai (CN); Suli Li, Zhuhai (CN)

(21) Appl. No.: 19/228,802

(22) Filed: Jun. 5, 2025

(30) Foreign Application Priority Data
Jun. 25, 2024 (CN) 202421476925.9

(51) Int. Cl. H01M 10/0587; H01M 50/586; H01M 50/595

(52) U.S. Cl. CPC H01M 10/0587; H01M 50/586; H01M 50/595

(57) ABSTRACT

The present disclosure provides a jelly roll and a battery. The jelly roll comprises a first electrode plate with a first electrode tab, a separator, and a second electrode plate with a stepped groove opposite to the electrode tab. The stepped groove comprises a first groove and a second groove that are arranged away from the first electrode tab and are in communication in sequence. A projection of the second groove is located within that of the first groove. An active layer ending portion and a termination adhesive tape are provided on one side of a winding tail end of the first electrode plate, which side faces toward the second electrode plate. A head portion of the termination adhesive tape covers the active layer ending portion. Both the head portion of the termination adhesive tape and the active layer ending portion are located in the second groove.

### CROSS-REFERENCE TO RELATED APPLICATIONS

The present application claims priority to Chinese Patent Application No. 202421476925.9, filed on Jun. 25, 2024, which is hereby incorporated by reference in its entirety.

### FIELD

The present disclosure pertains to the technical field of battery energy, and particularly relates to a jelly roll and a battery.

### BACKGROUND

With the rapid development of the battery technology, people have put forward higher requirements for battery energy density, fast charging capability, and charge-discharge rate. Fast charging batteries with high energy density are also the development trend of consumer batteries.

At present, during manufacturing, jelly rolls of some batteries are formed by stacking a positive electrode plate, a separator, and a negative electrode plate together, and then winding them from the head portion to the trailing portion, with the head portion of the negative electrode plate as the center.

Wherein, due to the difference between the electrode tab thickness and the paste thickness, the centered electrode tab structure leads to a thickness difference between electrode tab positions and non-electrode-tab positions and a decrease in the flatness of the jelly roll. During formation, it is easy to generate uneven pressure near electrode tabs and leave gaps in the interface bonding area, thereby causing the problem of lithium precipitation at the electrode tab positions, and seriously affecting the cycling performance and safety of the battery.

### SUMMARY

Based on this, the present disclosure provides a jelly roll and a battery to solve the problems that due to the thickness difference, the pressure is uneven, gaps appear in the interface, lithium is precipitated at the electrode tab positions, and the battery performance is affected in related technologies.

The jelly roll provided by the present disclosure comprises a first electrode plate, a separator, and a second electrode plate that are stacked and wound together; the first electrode plate is of opposite polarity to the second electrode plate;
a first electrode tab is arranged on the first electrode plate, and a stepped groove opposite to the first electrode tab is arranged on the second electrode plate; the stepped groove comprises a first groove and a second groove that are arranged away from the first electrode tab and in communication in sequence, and in a thickness direction of the jelly roll, a projection of the second groove is located within that of the first groove;
an active layer ending portion and a termination adhesive tape are provided on one side of a winding tail end of the first electrode plate, which side faces toward the second electrode plate; a head portion of the termination adhesive tape covers the active layer ending portion;
wherein, in the thickness direction of jelly roll, both an orthographic projection of the head portion of the termination adhesive tape and an orthographic projection of the active layer ending portion are located in the second groove.

In a specific embodiment, the first electrode plate comprises a first current collector, and a first active layer and a second active layer that are located on opposite sides of the thickness direction of the first current collector, respectively; in a winding direction, in the active layer ending portion, a termination end of the first active layer is flush with that of the second active layer; or, the termination end of the first active layer extends beyond that of the second active layer; or, the termination end of the second active layer extends beyond that of the first active layer.

In a specific embodiment, the stepped groove comprises a third groove that is arranged away from the first groove and is in communication with the second groove, the projection of the third groove is located within that of the second groove in the thickness direction of the jelly roll, and a first step surface of the first groove and a third step surface of the third groove are located on both sides of a second step surface of the second groove, respectively;

the first step surface has a depth of h1, the second step surface has a depth of h2, and the third step surface has a depth of h3, wherein, h1, h2, and h3 satisfy: 0<h1≤h2≤h3.

In a specific embodiment, the first electrode plate comprises a first current collector and first active material layers that are respectively located on opposite sides of the thickness direction of the first current collector, and the second electrode plate comprises a second current collector and second active material layers that are respectively located on opposite sides of the thickness direction of the second current collector;
h1 satisfies: h1<h3−the thickness of the first electrode tab; and/or
h2 satisfies: h2<h3−2× the thickness of the first active material layers;
h3 satisfies: h3 is equal to the thickness of the second active material layers.

In a specific embodiment, h1 satisfies: h1=h3−½ of the thickness of the first electrode tab; and/or h2 satisfies: h2=h3−the thickness of the first active material layers.

In a specific embodiment, the winding tail end of the first electrode plate is provided with a termination groove, and the head portion of the termination adhesive tape is located in the termination groove.

In a specific embodiment, the jelly roll further comprises a first protective tape, which is arranged on the first electrode plate and covers the first electrode tab, and the first protective tape extends in a winding direction of the jelly roll and at least partially covers an arc segment on one side of the jelly roll, which side is adjacent and closest to the first electrode tab.

In a specific embodiment, the jelly roll further comprises a second protective tape, which is arranged on the second electrode plate and covers the stepped groove.

In a specific embodiment, in a width direction of the second electrode plate, there is a gap between an edge of the stepped groove and that of the second electrode plate.

In a specific embodiment, the first electrode plate comprises a first current collector and first active material layers that are respectively located on opposite sides of the thickness direction of the first current collector, and first concave portions are opened on the first active material layers; and/or,

the second electrode plate comprises a second current collector and second active material layers that are respectively located on opposite sides of the thickness direction of the second current collector, and second concave portions are opened on the second active material layers.

The present disclosure provides a battery, comprising a casing and the above jelly roll, and the jelly roll is located within the casing.

In the jelly roll and the battery provided by the present disclosure, the jelly roll is connected to the termination adhesive tape at the winding tail end of the first electrode tab, and in the thickness direction of the jelly roll, the projection of the connection region between the termination adhesive tape and the first electrode plate is located within the second groove of the stepped groove, so that the thickness of both the first electrode tab and the first electrode plate at the winding tail end is accommodated in the stepped groove, and the step transition is reduced at the active layer ending portion, which reduces the thickness difference between adjacent positions near the electrode tab positions, and improves the flatness of the jelly roll, thereby reducing the uneven pressure near the electrode tabs during formation, avoiding generating gaps in the interface bonding area, and alleviating the problem of lithium precipitation at the electrode tab positions.

### BRIEF DESCRIPTION OF THE DRAWINGS

In order to illustrate the technical solutions in the embodiments of the present disclosure or in the prior art more clearly, the figures that need to be used in the description of the embodiments or the prior art will be introduced below in a brief manner. Obviously, the figures described below relate to some embodiments of the present disclosure, and for those of ordinary skill in the art, other figures can be further obtained on the basis of these figures without creative efforts.

FIG. 1 is a structure diagram of the jelly roll provided in the embodiments of the present disclosure;

FIG. 2 is another structure diagram of the jelly roll provided in the embodiments of the present disclosure;

FIG. 3 is a structure diagram of the first electrode tab position in the jelly roll of FIG. 1;

FIG. 4 is a structure diagram of the first electrode tab position in the jelly roll of FIG. 2;

FIG. 5 is an enlarged structure diagram of Part A in FIG. 3;

FIG. 6 is a diagram of the positional correspondence between the first electrode plate and the second electrode plate of the jelly roll provided in the embodiments of the present disclosure;

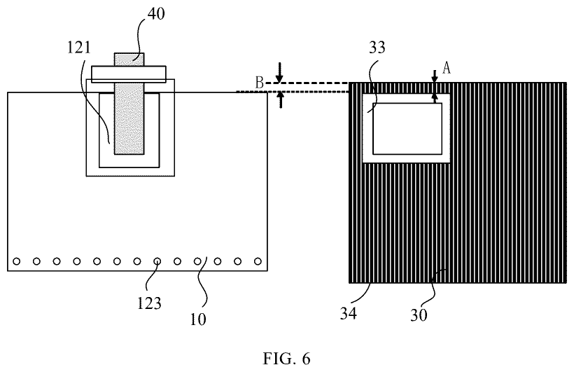

FIG. 7 is a structure diagram of a jelly roll in a comparative embodiment.

### DESCRIPTION OF REFERENCE SIGNS

100—jelly roll; 10—first electrode plate; 11—first current collector; 12—first active material layer; 121—first electrode tab groove; 123—first recess; 13—first active layer; 14—second active layer; 20—separator; 30—second electrode plate; 31—second current collector; 32—second active material layer; 33—stepped groove; 331—first groove; 332—second groove; 333—first step surface; 334—second step surface; 335—third step surface; 34—second recess; 40—first electrode tab; 50—second electrode tab; 60—termination adhesive tape; 70—first protective tape; 200—arc segment; 300—straight segment.

### DETAILED DESCRIPTION

To make the objectives, technical solutions, and advantages of the present disclosure clearer, the technical solutions in the embodiments of the present disclosure will be described below in greater detail in combination with the drawings in the preferred embodiments of the present disclosure. The same or similar reference signs throughout the drawings indicate the same or similar components or components with the same or similar functions. The described embodiments are some of the embodiments of the present disclosure, rather than all of them. The embodiments described below with reference to the drawings are exemplary and intended to explain the present disclosure, and should not be construed as limitations upon the present disclosure. All other embodiments obtained by those of ordinary skill in the art without creative efforts on the basis of the embodiments in the present disclosure fall within the scope of protection of the present disclosure. The embodiments of the present disclosure will be described below in detail with reference to the drawings.

In the description of the present disclosure, it should be noted that unless otherwise specified and limited, the terms “mount”, “link”, and “connect” should be understood in a broad sense. For example, they can be fixed connection, indirect connection through an intermediate medium, internal communication between two elements, or interaction between two elements. For those of ordinary skill in the art, the specific meanings of the above terms in the present disclosure can be understood according to the specific situations.

In the description of the present disclosure, it should be understood that orientations or positional relationships indicated by the terms such as “up”, “down”, “front”, “rear”, “vertical”, “horizontal”, “top”, “bottom”, “inside”, and “outside” are those based on the drawings, merely in order to facilitate describing the present disclosure and simplifying the description, rather than indicate or imply that devices or elements concerned must have particular orientations, or be constructed and operated in particular orientations. Therefore, these terms cannot be understood as limitations upon the present disclosure.

The terms “first”, “second”, and “third” (if any) in the specification and claims of the present disclosure, as well as the above drawings, are used to distinguish similar objects, and do not have to be used to describe a particular order or sequence.

In addition, the terms “comprise” and “have”, as well as any variations thereof, are intended to cover non-exclusive inclusions. For example, a process, a method, a system, a product, or a display that comprises a series of steps or units does not have to be confined to those steps or units that are listed clearly, but can comprise other steps or units that are not listed clearly or are inherent to the process, method, product or display.

At present, in the prior art, a jelly roll is formed by stacking a positive electrode plate, a separator, and a negative electrode plate together, and then winding them from the head portion to the trailing portion, with the head portion of the negative electrode plate as the center. Wherein, electrode tabs are welded on corresponding electrode plates by means of grooves on the electrode plates through laser or ultrasonic wave. Since the thickness of the electrode tabs is different from that of the paste of the active material on the electrode plates in the centered electrode tab structure (the electrode tabs are located in the middle of the electrode plates, and after winding, the electrode tabs are located in the middle of the jelly roll), there is a thickness difference between electrode tab positions and non-electrode-tab positions on the electrode plates. After the jelly roll is formed by winding, there are regions of different thicknesses on the surface of the jelly roll, which affects the flatness of the jelly roll. During formation, it is easy to generate uneven pressure near the electrode tab positions and leave gaps in the interface bonding area, thereby causing the problem of lithium precipitation at the electrode tab positions, and affecting the cycling performance and safety of the finally formed battery.

After repeated thinking and verification, the inventors found that if a stepped groove opposite to the first electrode tab is arranged on the second electrode plate, the arrangement that the winding tail end of the first electrode plate in the termination area of the jelly roll does not go beyond the projection region of the first electrode tab during winding and is projected into the stepped groove can alleviate the problem of uneven surface of the jelly roll as caused by the difference between the electrode plate thickness and the paste thickness, reduce the possibility of generating gaps at the interface area, and improve the cycling performance of the battery.

Given this, the present disclosure provides a jelly roll, comprising a first electrode plate, a separator, a second electrode plate that are stacked and wound together; the first electrode plate is of opposite polarity to the second electrode plate; a first electrode tab is arranged on the first electrode plate, and a stepped groove opposite to the first electrode tab is arranged on the second electrode plate; the stepped groove comprises a first groove and a second groove that are arranged away from the first electrode tab and are in communication in sequence, and in a thickness direction of the jelly roll, a projection of the second groove is located within that of the first groove; an active layer ending portion and a termination adhesive tape are provided on one side of a winding tail end of the first electrode plate, which side faces toward the second electrode plate; a head portion of the termination adhesive tape covers the active layer ending portion; wherein, in the thickness direction of jelly roll, both an orthographic projection of the head portion of the termination adhesive tape and an orthographic projection of the active layer ending portion are located in the second groove.

The jelly roll is connected to the termination adhesive tape at the winding tail end of the first electrode tab, and in the thickness direction of the jelly roll, the orthographic projection of the connection region between the termination adhesive tape and the first electrode plate is located within the second groove of the stepped groove, so that the thickness of both the first electrode tab and the first electrode plate at the winding tail end is accommodated in the stepped groove, and the step transition is reduced at the active layer ending portion, which reduces the thickness difference between adjacent positions near the electrode tab positions, and improves the flatness of the jelly roll, thereby reducing the uneven pressure near the electrode tabs during formation, avoiding generating gaps in the interface bonding area, and alleviating the problem of lithium precipitation at the electrode tab positions.

The content of the present disclosure will be described below in detail in combination with the drawings, so as to enable those skilled in the art to have a clearer and more detailed understanding of the content of the present disclosure.

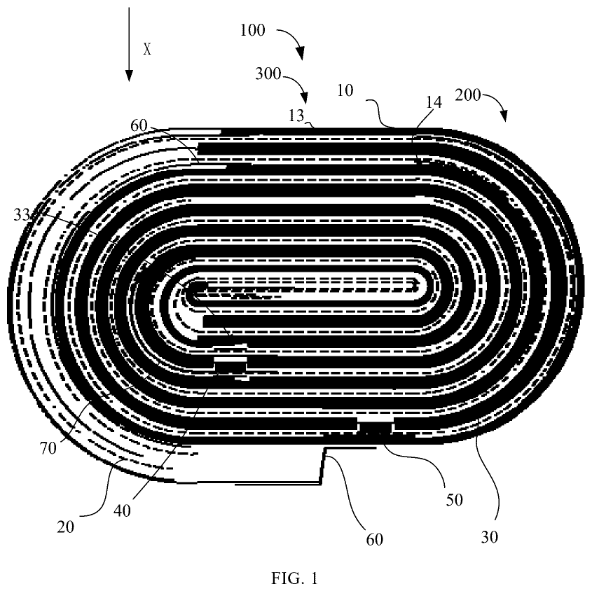

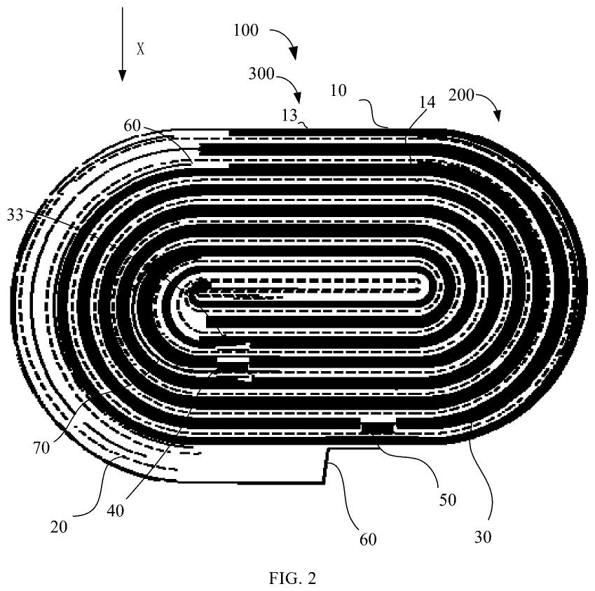

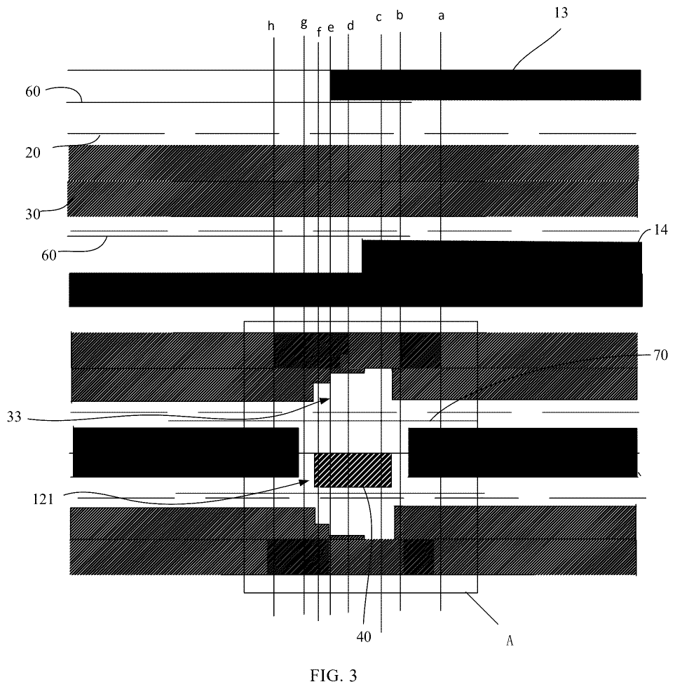

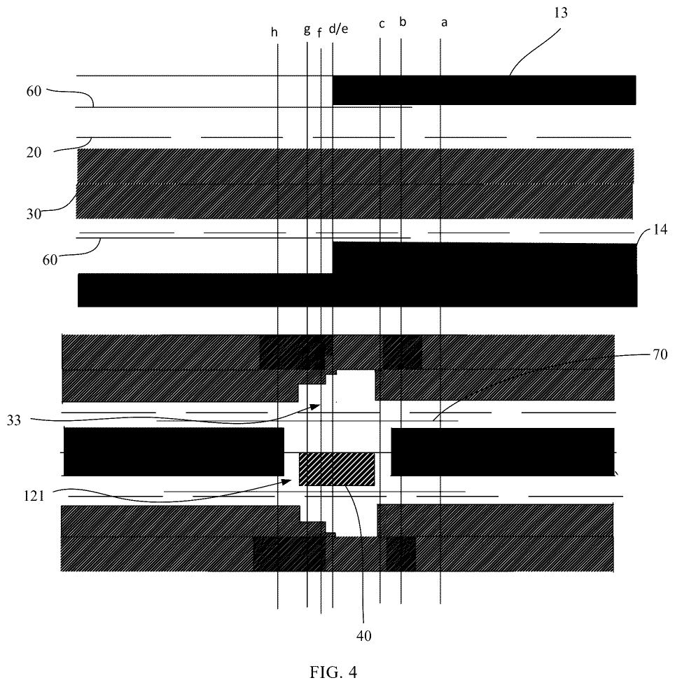

FIG. 1 is a structure diagram of the jelly roll provided in the embodiments of the present disclosure, FIG. 2 is another structure diagram of the jelly roll provided in the embodiments of the present disclosure, FIG. 3 is a structure diagram of the first electrode tab position in the jelly roll of FIG. 1, and FIG. 4 is a structure diagram of the first electrode tab position in the jelly roll of FIG. 2.

As shown in FIGS. 1 to 4, the embodiments of the present disclosure provide a jelly roll 100, which comprises a first electrode plate 10, a separator 20, and a second electrode plate 30 that are stacked and wound together. The first electrode plate 10 is of opposite polarity to the second electrode plate 30, and the separator 20 is located between the first electrode plate 10 and the second electrode plate 30 that are adjacent to each other, so as to avoid contact short circuit between the first electrode plate 10 and the second electrode plate 30.

As shown in FIG. 1, the jelly roll 100 is provided with an arc segment 200. It can be understood that the arc segment 200 is a region where the first electrode plate 10, the separator 20, and the second electrode plate 30 bend during winding. For example, as shown in FIG. 1, both ends of the jelly roll 100 in both left and right directions are arc segments 200. Optionally, the jelly roll 100 further comprises a straight segment 300 connected to the arc segment 200.

The jelly roll 100 further comprises a first electrode tab 40, a second electrode tab 50, and a termination adhesive tape 60. The first electrode tab 40 is located on the first electrode plate 10, and the second electrode tab 50 is located on the second electrode plate 30. An active layer ending portion is provided on one side of the winding tail end of the first electrode plate 10, which side faces toward the second electrode plate 30. The termination adhesive tape 60 is connected to the winding tail end of the first electrode plate 10, and a head portion of the termination adhesive tape 60 covers the active layer ending portion. In the thickness direction of the jelly roll 100, i.e., in the X direction in FIG. 1, the orthographic projection of the connection region between the termination adhesive tape 60 and the active layer ending portion of the first electrode plate 10, relative to the first electrode tab 40, is distal from the arc segment 200 of the jelly roll 100 which is adjacent and closest to the first electrode tab 40, i.e., it is located on one side of the first electrode tab 40, which side is distal from the arc segment 200 of the jelly roll 100 which is adjacent and closest to the first electrode tab 40, so that the termination end of the jelly roll 100 does not extend beyond the position of the first electrode tab 40.

The projection of the winding tail end of the first electrode plate 10 falls on an electrode tab position, which can reduce the thickness difference caused by the reduction of the first electrode plate 10 at the termination position of the jelly roll 100 and improve the flatness of the jelly roll 100.

Preferably, since the termination end of the first electrode plate 10 on the surface of the jelly roll 100 does not extend beyond the position of the first electrode tab 40, the thickness difference between adjacent positions is ≤40 μm, which can reduce the uneven pressure on the first electrode tab 40 during formation and reduce the occurrence of interface gaps.

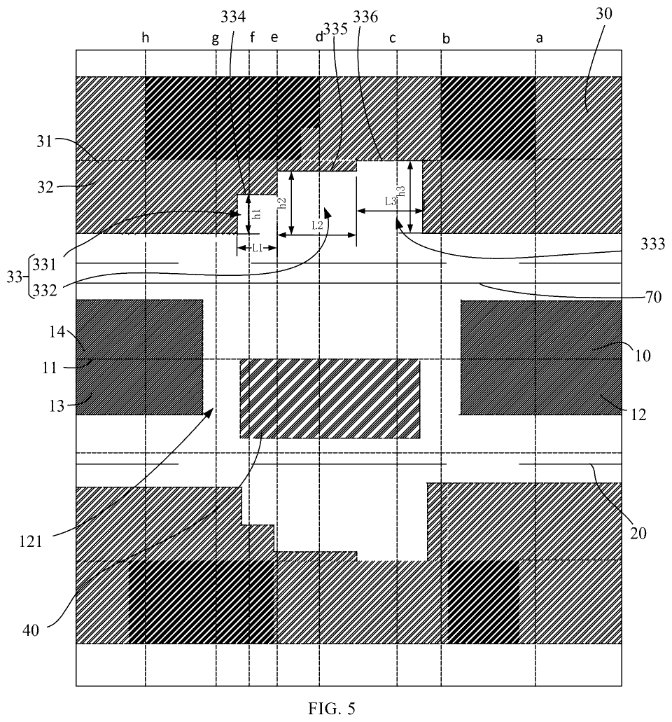

As shown in FIG. 5, the first electrode plate 10 comprises a first current collector 11 and two first active material layers 12; the two first active material layers 12 are located on opposite sides of the thickness direction of the first current collector 11, respectively; a first electrode tab groove 121 is arranged on the first active material layer 12; the first electrode tab groove 121 has a bottom wall that is the first current collector 11 and a peripheral side that is the first active material layer 12; a first electrode tab 40 electrically connected to the first current collector 11 is arranged in the first electrode tab groove 121.

In a specific embodiment, the two first active material layers 12 are a first active layer 13 and a second active layer 14, respectively; in the thickness direction of the jelly roll, in the active layer ending portion of the first electrode plate 10, the projection of the termination end of the first active layer 13 overlaps with that of the termination end of the second active layer 14, as shown in FIG. 2; alternatively, the projection of the termination end of the first active layer 13 is longer than that of the termination end of the second active layer 14, as shown in FIG. 1; alternatively, the projection of the termination end of the first active layer 13 is shorter than that of the termination end of the second active layer 14. In other words, in the winding direction, the termination end of the first active layer 13 is flush with the termination end of the second active layer 14; alternatively, the termination end of the first active layer 13 extends beyond the termination end of the second active layer 14; alternatively, the termination end of the second active layer 14 extends beyond the termination end of the first active layer 13.

The first electrode plate 10 comprises a double-sided region, a single-sided region, and an uncoated foil region. The double-sided region refers to a region where the first active material layers 12 exist simultaneously on both sides of the first current collector 11. The single-sided region refers to a region where the first active material layer 12 only exists on one side of the first current collector 11. The uncoated foil region refers to a region where only the first current collector 11 exists. Wherein, on the first electrode plate 10, the double-sided region, the single-sided region, and the uncoated foil region are connected in sequence, so as to terminate with the uncoated foil region at the trailing portion of the first electrode plate 10. The trailing portion of the termination adhesive tape 60 covers the uncoated foil region.

The second electrode plate 30 comprises a second current collector 31 and two second active material layers 32; the two second active material layers 32 are located on opposite sides of the thickness direction of the second current collector 31, respectively; a second electrode tab groove is arranged on the second active material layer 32; the second electrode tab groove has a bottom wall that is the second current collector 31 and a peripheral side that is the second active material layer 32; a second electrode tab 50 electrically connected to the second current collector 31 is arranged in the second electrode tab groove.

For example, the first electrode plate 10 can be a positive electrode plate, and the second electrode plate 30 can be a negative electrode plate; alternatively, the first electrode plate 10 can be a negative electrode plate, and the second electrode plate 30 can be a positive electrode plate. Herein, exclusive limitation is not imposed. When the first electrode plate 10 is a positive electrode plate and the second electrode plate 30 is a negative electrode plate, aluminum foil can be used as the first current collector 11, and copper foil can be used as the second current collector 31.

As shown in FIGS. 3 to 5, in a specific embodiment, a stepped groove 33 is arranged on the second electrode plate 30. The stepped groove 33 is arranged opposite to the first electrode tab 40. The stepped groove 33 comprises a first groove 331 and a second groove 332 that are arranged away from the first electrode tab 40 and are in communication in sequence. In the thickness direction of the jelly roll 100, the projection of the second groove 332 is located within that of the first groove 331.

In the orthographic projection in the thickness direction of the jelly roll 100, both the head portion of the termination adhesive tape 60 and the active layer ending portion are located in the second groove 332.

By adjusting the depth of different steps in the stepped groove 33, the thickness difference caused by the first electrode tab 40, the electrode tab attachment adhesive, and the decrease in the number of layers in the termination area of the first electrode plate 10, as well as the termination adhesive tape 60, can be further reduced at the position of the first electrode tab 40, and the flatness of the jelly roll 100 is improved.

Preferably, in the thickness direction of the jelly roll 100, the stepped groove 33 is located between the first electrode tab 40 and the termination end of the first electrode plate 10, so that on the side distal from the termination end of the jelly roll 100, the electrode plates are stacked in a relatively flat manner, which reduces the flatness fluctuation caused by opening holes and grooves in the thickness direction of the jelly roll 100. On the other hand, after the thickness of the first electrode tab 40 is accommodated in the stepped groove 33, the overall thickness of the jelly roll 100 can also be reduced, which improves the space utilization rate of the jelly roll 100, thereby improving the energy density.

Preferably, the stepped groove 33 is opened on the second active material layer 32 adjacent to the first electrode tab 40, so that the first electrode tab 40 that affects the flatness of the jelly roll 100 is adjacent to the groove, thereby increasing the accommodation of the thickness of the first electrode tab 40 in the stepped groove 33, reducing the overall thickness of the jelly roll 100, and alleviating the flatness fluctuation caused by arranging the first electrode tab 40 in the thickness direction.

As shown in FIG. 5, the stepped groove 33 comprises a third groove 333 that is arranged away from the first groove 331 and is in communication with the second groove 332. In the thickness direction of the jelly roll 100, the projection of the third groove 333 is located within that of the second groove 332. A first step surface 334 of the first groove 331 and a third step surface 336 of the third groove 333 are located on both sides of a second step surface 335 of the second groove 332, respectively. In the length direction of the second electrode plate 30, the sum of the width of the first step surface 334, the second step surface 335, and the third step surface 336 is consistent with the width of the first electrode tab 40.

As shown in FIG. 3, the width L1 of the first step surface 334 is the distance from the position of the projection of the first electrode tab 40 on the side proximal to the arc segment 200 of the jelly roll to that of the projection of the active layer ending portion adjacent thereto in the thickness direction of the jelly roll 100.

The width L2 of the second step surface 335 is the distance from the position of the projection of the termination end of the first active layer 13 to that of the projection of the termination end of the second active layer 14 in the thickness direction of the jelly roll 100, i.e., the displacement distance between termination paste on the inner side and that on the outer side, with a process allowance of +1 mm reserved.

The width L3 of the third step surface 336 is the distance from the position of the projection of the first electrode tab 40 on the side distal from the arc segment 200 of the jelly roll to that of the projection of the other active layer ending portion in the thickness direction of the jelly roll 100.

The connection region between the termination adhesive tape 60 and the active layer ending portion of the first electrode plate 10 is thicker than other regions where the first electrode plate 10 terminates due to the addition of the termination adhesive tape 60. By overlapping the projection of the second step surface 335 therewith, the increased thickness can be accommodated in the second step surface 335, so as to improve the flatness at this position. Moreover, the overall thickness of the jelly roll 100 can be further reduced, which improves the space utilization rate of the jelly roll 100, thereby improving the energy density.

For example, due to fluctuations in the manufacturing process, the width L1 of the first step surface 334, the width L2 of the second step surface 335, and the width L3 of the third step surface 336 can all be increased by an error of 2 mm to 5 mm on the basis of the above dimensions.

In a specific embodiment, the first step surface 334 has a depth of h1, the second step surface 335 has a depth of h2, and the third step surface 336 has a depth of h3, wherein h1, h2, and h3 satisfy: 0<h1≤h2≤h3.

Due to the presence of the first electrode tab 40, the termination end of the first electrode plate 10, and the starting end of the termination adhesive tape 60 at the second step surface 335 and the third step surface 336 in the thickness direction of the jelly roll 100, the thickness here is larger than in other regions. The arrangement that h1, h2, and h3 satisfy 0<h1≤h2≤h3 can improve the accommodation capability of the second step surface 335 and the third step surface 336 in the thickness direction, so as to reduce the thickness at the position of the step groove 33 on the jelly roll 100, and decrease the thickness variation, thereby improving the flatness of the jelly roll 100 at the position of the step groove 33.

As shown in FIGS. 1 and 2, the jelly roll 100 further comprises a first protective tape 70. The first protective tape 70 is arranged on the first electrode plate 10. The first protective tape 70 covers the first electrode tab 40.

For example, on the straight segment 300, the position of the first protective tape 70 distal from the arc segment 200 relative to the first electrode tab 40 and the position where the projection of the termination end of the first active layer 13 overlaps with that of the termination end of the second active layer 14 are defined as Position a; the position which is in the first electrode tab groove 121 without arranging the first electrode tab 40 and overlaps with the projection of the termination adhesive tape 60 is defined as Position b; the position at the third step surface 336 is defined as Position c; the position at the second step surface 335 is defined as Position d; the position which is in the second step surface 335 and overlaps with the terminal of the active layer ending portion (the active material layer ending portion relatively close to the arc segment 200 that is adjacent to the first electrode tab 40) on the outer side is defined as Position e; the position at the first step surface 334 is defined as position f; the position which is in the first electrode tab groove 121 without arranging the first electrode tab 40 and is distal from Position b relative to the first electrode tab 40 is defined as Position g; the position where the projection of the termination adhesive tape 60 overlaps with the double-sided region of the first electrode tab groove 121 on the side close to the arc segment 200 is defined as Position h.

The depth h1 of the first step surface 334 is the thickness step that balances Position e and Position g. Therefore, 0<h1<h3−the thickness difference between Position e and Position g.

Since the thickness difference between Position e and Position g is approximately the thickness of the first electrode tab 40, the depth h1 of the first step surface 334 satisfies: 0<h1<h3−the thickness of the first electrode tab 40.

The depth h2 of the second step surface 335 is the thickness step that balances Position c and Position g. Therefore, 0<h1<h3−the thickness difference between Position c and Position g.

Since the thickness difference between Position c and Position g is approximately twice the thickness of the first active material layer 12, the depth h2 of the second step surface 335 satisfies: h2<h3−2× the thickness of the first active material layer 12.

The depth h3 of the third step surface 336 satisfies: h3 is equal to the thickness of the second active material layer 32, i.e., the third step surface 336 has the second current collector 31 as a bottom wall.

Preferably, h1 satisfies: h1=h3−½ of the thickness of the first electrode tab 40.

Preferably, h2 satisfies: h2=h3−the thickness of the first active material layer 12.

For example, due to fluctuations in the manufacturing process, the depth h1 of the first step surface 334, the depth h2 of the second step surface 335, and the depth h3 of the third step surface 336 can all have an error of ±10 μm based on the above dimensions.

In one possible implementation, the winding end of the first electrode plate 10 is provided with a finishing groove.

In a specific embodiment, the winding tail end of the first electrode plate 10 is provided with a termination groove. The head portion of the termination adhesive tape 60 is located in the termination groove.

Specifically, the termination groove is opened at the tail end of the first active material layer 12.

The arrangement of the termination groove reduces the thickness of the connection region between the termination adhesive tape 60 and the first electrode plate 10, thereby reducing the thickness variation of the first electrode plate 10 near the termination position, reducing the thickness difference at the termination end of the first electrode plate 10 as caused by decreasing the number of layers, and improving the flatness of the jelly roll 100.

Preferably, the depth of the termination groove is greater than or equal to the thickness of the termination adhesive tape 60, so that the thickness of the connection region between the termination adhesive tape 60 and the first electrode plate 10 is not greater than that of the first electrode plate 10 near the termination area; as a result, the change in thickness of the first electrode plate 10 at the termination area gradually decreases, without sudden increase.

As shown in FIG. 1, in a specific embodiment, the first protective tape 70 extends in the winding direction of the jelly roll 100 and at least partially covers the arc segment 200 on one side of the jelly roll 100, which side is adjacent and closest to the first electrode tab 40.

The first protective tape 70 covers the arc segment 200, which can increase the thickness of the arc segment 200 as compared with the straight segment 300. As a result, in the hot-pressing course of the jelly roll 100, the interfaces are bonded more tightly after the arc segment 200 is subjected to force, which solves the problem of poor adhesion between the separator 20 and the positive and negative electrodes on the arc segment 200, and improves the long-term cycling performance of the battery.

In a specific embodiment, the jelly roll 100 further comprises a second protective tape, which is arranged on the second electrode plate 30 and covers the stepped groove 33.

As shown in FIG. 4, in a specific embodiment, there is a gap between the edge of the step groove 33 and that of the second electrode plate 30 adjacent to the first electrode tab 40 in the width direction of the second electrode plate 30, i.e., there is a second active material layer 32 between the edges of the step groove 33 and the second electrode plate 30. The gap has a width of A in the width direction of the second electrode plate 30.

The negative electrode of a conventional lithium-ion battery is wider than the positive electrode, i.e., there is an overhang in the width direction. The width difference is denoted as B. By arranging the gap, the second active material layer 32 at the gap can tightly abut against the first electrode tab 40, which prevents the interface gap from being overly huge, alleviates the problem of lithium precipitation at the electrode tabs, and can also improve the heat conduction efficiency on the electrode plates.

Preferably, A≥B, which makes the contact between the electrode plates at this position wider and the bonding tighter.

In a specific embodiment, multiple first concave portions 123 are opened on the first active material layer 12. The first concave portions 123 can be recesses or strip-shaped grooves.

The recesses are through holes, blind holes, or countersunk holes on the first electrode plate 10. The strip-shaped grooves are linear grooves that extend in the length direction of the electrode plates.

The concave portions arranged on the positive electrode plate can remove some active materials and increase the CB (Cell Balance) value at the corresponding positions, and the hole structures can also store electrolyte, improve the wetting performance of electrolyte on the electrode plates, and further improve the lithium precipitation phenomenon.

Preferably, the first concave portions 123 are voids, and they can be opened at the edge of the first electrode plate 10, the arc segment 200, the edge of the first electrode tab 40, the edge of the termination adhesive tape 60, or the edge of the first protective tape 70, or on the entire surface of the first electrode plate 10, which can increase the CB value at the corresponding positions and improve phenomena such as lithium precipitation at edges, lithium precipitation on arcs, and lithium precipitation at electrode tab positions on the jelly roll 100.

The strip-shaped grooves can be made on the first electrode plate 10 by laser scoring.

In a specific embodiment, multiple second concave portions 34 are opened on the second active material layer 32.

The second concave portions 34 opened on the negative electrode can increase the lithium insertion speed at the corresponding positions and improve the negative electrode dynamics, thereby increasing the negative electrode surface density, improving the overall energy density of the battery, and slowing down the lithium precipitation. In addition, they can also increase the electrolyte retention capacity.

The second concave portions 34 can be second voids opened on the second electrode plate 30 or recesses opened on the first active material layer 12.

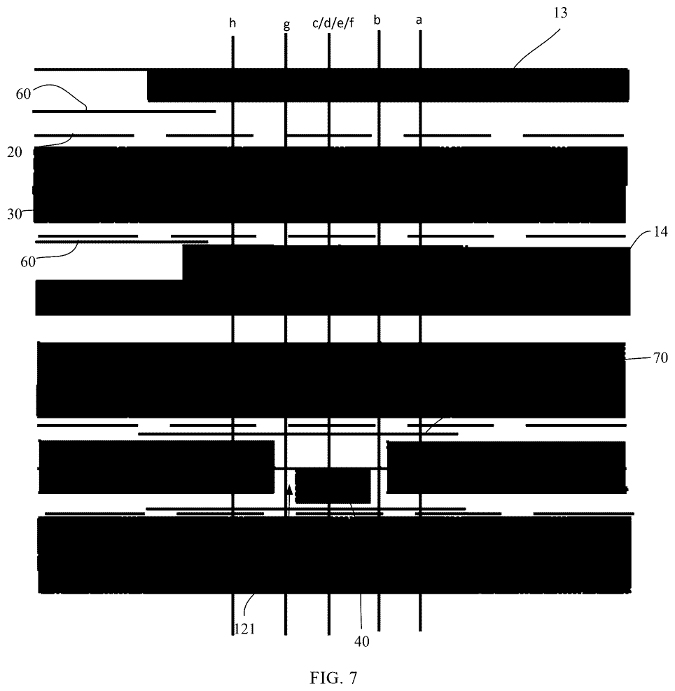

As shown in FIG. 7, it is a structure diagram of a jelly roll in a comparative embodiment shown in the prior art.

The difference between the comparative embodiment and the embodiments of the present disclosure is that there is no recess on the second electrode plate 30 corresponding to the welding region of the first electrode tab 40 in the comparative embodiment, and the first active material layer 12 at the termination end of the first electrode plate 10 of the jelly roll extends beyond the first electrode tab 40 and is closer to the arc segment 200 on the side adjacent and closest to the first electrode tab 40.

The table for comparing the thickness data of the embodiments of the present disclosure and the comparative embodiment is shown below. Wherein, the positions in the comparative embodiment are consistent with those in embodiments of the present disclosure relative to the first electrode tab 40.

Table 1 is a table of thickness data (unit: μm) at positions of Embodiment 1, Embodiment 2, and the comparative embodiment

| | Embodiment | | Embodiment | | Comparative | |
|---|---|---|---|---|---|---|
| | 1 | Range | 2 | Range | Embodiment | Range |
| a | w + 518 | | w + 518 | | w + 518 | |
| b | w + 434 | 844 | w + 434 | 84 | w + 410 | 108 |
| c | w + 504 | −70 | w + 504 | −70 | w + 580 | −170 |
| d | w + 473 | 31 | w + 442 | 62 | w + 580 | 0 |
| e | w + 442 | 31 | w + 442 | 0 | w + 580 | 0 |
| f | w + 441 | 1 | w + 441 | 1 | w + 580 | 0 |
| g | w + 442 | −1 | w + 442 | −1 | w + 480 | 100 |
| h | w + 480 | −38 | w + 480 | −38 | w + 542 | −62 |

Wherein, w is the total thickness of other regions of the jelly roll, and the range is the thickness difference value between adjacent positions.

As can be learned from comparison with the results of the embodiments, by arranging the step groove 33, the range between adjacent positions in the electrode tab region (Position b to Position h) can be reduced from the maximum value of 170 μm in the comparative embodiment to the maximum value of 84 μm, falling within 100 μm; in particular, the range at Position c and Position g is significantly reduced, which improves the interface adhesion force in the electrode tab region. Moreover, the thickness variation at the positions also decreases, i.e., it is smoother. Therefore, during formation, the pressure near the electrode tabs is more uniform, the probability of gaps in the interface bonding area is smaller, and the problem of lithium precipitation at the electrode tab positions is alleviated.

Wherein, the battery is not confined to a lithium battery. In the future, the technology may be applied to a sodium battery among others. A lithium-ion battery is preferred in the embodiments of the present disclosure.

In addition, the embodiments of the present disclosure further provide a battery, comprising a battery casing and a jelly roll 100. The jelly roll 100 is located within the battery casing.

Wherein, the specific structure, working principle, and function of the jelly roll 100 have been described in detail in the aforementioned embodiments, and will not be repeated herein. It should be noted that the preparation course of the lithium-ion battery is as follows:
Step 1: preparation of the positive electrode plate: positive electrode active layer slurry is prepared; the positive electrode active material slurry is applied on the surface of the current collector; after baking and rolling, the first electrode plate 10 is obtained; the first electrode plate 10 has a thickness of 70 μm; the first electrode tab groove 121 in fixed size is at a certain position of the first electrode plate 10; the first electrode tab 40 with a thickness of 100 μm is welded into the first electrode tab groove 121 by laser or ultrasonic wave; the first protective tapes 70 with a thickness of 12 μm are attached to both sides of the electrode plate in the first electrode tab groove 121;
Step 2: negative electrode active layer slurry is prepared; the negative electrode slurry is applied on a carbon-coated copper foil; after baking and rolling, the second electrode plate 30 with a thickness of 105 μm is obtained. The second electrode tab groove with a fixed size is at a certain position of the second electrode plate 30; the second electrode tab 50 is welded in the groove position by laser or ultrasonic wave; tapes with a thickness of 12 μm is attached on both sides of the electrode plate in the second electrode tab groove; in addition, the step groove 33 is cleaned on the second electrode plate 30 corresponding to the welding region of the first electrode tab 40, wherein, the first step surface 334 has a width of 3 mm and a depth of 30 μm, the second step surface 335 has a width of 3 mm and a depth of 45 μm, and the third step surface 336 has a width of 3 mm and a depth of 50 μm; the copper foil is visible to the naked eye;
Step 3: after the positive and negative electrode plates undergo slitting and plate forming, they are wound together with the separator to obtain the jelly roll; the paste on the trailing portion of the positive electrode of the jelly roll is mapped onto the first electrode tab 40; the termination adhesive tape 60 covers the positive electrode paste at a width of 3 mm; the distance from the termination adhesive tape 60 to the left and right sides of the first electrode tab groove 121 is 3.5 mm;
Step 4: after encapsulation, baking, liquid injection, formation, secondary encapsulation, sorting, and OCV (open circuit voltage) testing, the lithium-ion battery is obtained.

Wherein, the electrolyte is a commercially available conventional electrolyte, and the lithium salt therein is LiFP₆.

Finally, it should be noted that the above embodiments are only used to illustrate the technical solutions of the present disclosure, and are not intended to be a limitation thereof; notwithstanding the detailed description of the present disclosure with reference to the foregoing embodiments, a person of ordinary skill in the art should understand that he or she can still make modifications to the technical solutions as documented in the foregoing embodiments, or make equivalent substitutions for some or all of the technical features therein; and these modifications or substitutions do not take the essence of the corresponding technical solutions out of the scope of the technical solutions of the embodiments of the present disclosure.

What is claimed is:

1. A jelly roll, comprising a first electrode plate, a separator, a second electrode plate that are stacked and wound together, wherein, the first electrode plate is of opposite polarity to the second electrode plate;
a first electrode tab is arranged on the first electrode plate, and a stepped groove opposite to the first electrode tab is arranged on the second electrode plate; the stepped groove comprises a first groove and a second groove that are arranged away from the first electrode tab and are in communication in sequence, and in a thickness direction of the jelly roll, a projection of the second groove is located within that of the first groove;
an active layer ending portion and a termination adhesive tape are provided on one side of a winding tail end of the first electrode plate, which side faces toward the second electrode plate; a head portion of the termination adhesive tape covers the active layer ending portion;
wherein, in the thickness direction of jelly roll, both an orthographic projection of the head portion of the termination adhesive tape and an orthographic projection of the active layer ending portion are located in the second groove.

2. The jelly roll according to claim 1, wherein the first electrode plate comprises a first current collector, and a first active layer and a second active layer that are located on opposite sides of the thickness direction of the first current collector, respectively; in a winding direction, in the active layer ending portion, a termination end of the first active layer is flush with that of the second active layer; or,
the termination end of the first active layer extends beyond that of the second active layer; or,
the termination end of the second active layer extends beyond that of the first active layer.

3. The jelly roll according to claim 1, wherein the stepped groove comprises a third groove that is arranged away from the first groove and is in communication with the second groove, the projection of the third groove is located within that of the second groove in the thickness direction of the jelly roll, and a first step surface of the first groove and a third step surface of the third groove are located on both sides of a second step surface of the second groove, respectively;
the first step surface has a depth of h1, the second step surface has a depth of h2, and the third step surface has a depth of h3, and h1, h2, and h3 satisfy: 0<h1≤h2≤h3.

4. The jelly roll according to claim 3, wherein the first electrode plate comprises a first current collector and first active material layers that are respectively located on opposite sides of the thickness direction of the first current collector, and the second electrode plate comprises a second current collector and second active material layers that are respectively located on opposite sides of the thickness direction of the second current collector;
h1 satisfies: h1<h3−the thickness of the first electrode tab; and/or
h2 satisfies: h2<h3−2× the thickness of the first active material layers;
h3 satisfies: h3 is equal to the thickness of the second active material layers.

5. The jelly roll according to claim 4, wherein h1 satisfies: h1=h3−½ of the thickness of the first electrode tab; and/or
h2 satisfies: h2=h3−the thickness of the first active material layers.

6. The jelly roll according to claim 1, wherein the winding tail end of the first electrode plate is provided with a termination groove, and the head portion of the termination adhesive tape is located in the termination groove.

7. The jelly roll according to claim 1, wherein the jelly roll further comprises a first protective tape, which is arranged on the first electrode plate and covers the first electrode tab, and the first protective tape extends in a winding direction of the jelly roll and at least partially covers an arc segment on one side of the jelly roll, which side is adjacent and closest to the first electrode tab.

8. The jelly roll according to claim 1, wherein the jelly roll further comprises a second protective tape, which is arranged on the second electrode plate and covers the stepped groove.

9. The jelly roll according to claim 1, wherein in a width direction of the second electrode plate, there is a gap between an edge of the stepped groove and that of the second electrode plate.

10. The jelly roll according to claim 1, wherein the first electrode plate comprises a first current collector and first active material layers that are respectively located on opposite sides of the thickness direction of the first current collector, and first concave portions are opened on the first active material layers; and/or,
the second electrode plate comprises a second current collector and second active material layers that are respectively located on opposite sides of the thickness direction of the second current collector, and second concave portions are opened on the second active material layers.

11. A battery, comprising a casing and the jelly roll according to claim 1, wherein the jelly roll is located within the casing.
